(19) United States
(12) Patent Application Publication
(10) Pub. No.: US 2018/0104734 A1
(43) Pub. Date: Apr. 19, 2018

(54) METHOD FOR ADJUSTING A PHASE OFFSET OF A MULTIPLE-ACTION MECHANICAL TRANSVERSE SHAFT PRESS, AND A PRESS ACCORDING TO SAID METHOD

(71) Applicant: SCHULER PRESSEN GMBH, Goppingen (DE)

(72) Inventors: Martin GAEBGES, Albershausen (DE); Daniel Eichler, Lorch (DE)

(73) Assignee: SCHULER PRESSEN GMBH, Goppingen (DE)

(21) Appl. No.: 15/843,148

(22) Filed: Dec. 15, 2017

Related U.S. Application Data
(63) Continuation of application No. PCT/EP2016/064596, filed on Jun. 23, 2016.

(30) Foreign Application Priority Data
Jul. 3, 2015 (DE) 10 2015 110 748.1

(51) Int. Cl. B21D 24/00; B30B 15/14

(52) U.S. Cl. CPC B21D 24/00; B30B 1/266; B30B 15/148

(57) ABSTRACT

A method for an adjustment of a phase shift of the movement of at least one internal ram, which is pivotally mounted by means of a drive shaft, in relation to the movement of at least one external ram, which is pivotally mounted by means of a drive shaft, of a multiple-action mechanical transverse shaft press. According to the invention, the method steps effected are a) stopping, delaying or accelerating at least one drive shaft and b) adjusting a phase angle of the at least one internal ram in relation to a phase angle of the at least one external ram by means of at least one electronically controlled rotational movement of at least one drive shaft.

### CROSS REFERENCE TO RELATED APPLICATIONS

This application is a continuation of International Application No. PCT/EP2016/064596 filed Jun. 23, 2016, which designated the United States, and claims the benefit under 35 USC § 119(a)-(d) of German Application No. 10 2015 110 748.1 filed Jul. 3, 2015, the entireties of which are incorporated herein by reference.

### FIELD OF THE INVENTION

The present invention relates to a method for an adjustment of a phase shift of the movement of at least one first ram, for example internal ram, which is pivotally mounted by means of a drive shaft, in relation to the movement of at least one second ram, for example external ram, of a multiple-action mechanical transverse shaft press with a belt running direction which is fixed for operation. The present invention also relates to a press which comprises a movement sequence corresponding to the claimed method.

### BACKGROUND OF THE INVENTION

Multiple-action mechanical presses and methods for the operation thereof are well known in the prior art. In this connection, a difference is made between so-called longitudinal shaft presses and so-called transverse shaft presses. Detailed articles in this connection can be found from the literature “Metal Forming Handbook/Schuler”, Springer-Verlag, 1998, page 63 et seq. The present invention relates to transverse shaft presses.

WO 2008/134990 A1 discloses a multi-ram forming press which is realized as a transfer step press with a longitudinal shaft. DE 10 2011 001 314 A1 discloses a draw press which has two couplable rams and can operate as a double-action press.

### SUMMARY OF THE INVENTION

Economic operation of multiple-action presses generally places high demands on the machines. Thus, it can be necessary, to alter conditions in the case of forming presses and consequently to provide increased flexibility for such machines. In particular, in the case of multiple-action transverse shaft presses disclosed in the prior art, there is the problem of not meeting those requirements. It is, consequently, the object of the present invention to provide a multiple-action mechanical transverse shaft press which, as regards its handling, can be operated in a more flexible manner.

A method for an adjustment of a phase shift of the movement of at least one first ram, for example internal ram, which is pivotally mounted by means of at least one drive shaft, in relation to the movement of at least one second ram, for example external ram, which is pivotally mounted by means of at least one drive shaft, of a multiple-action mechanical transverse shaft press is used to achieve the object of the present invention. The following method steps are effected in this connection according to the present invention:

a) stopping, delaying or accelerating at least one drive shaft;

b) adjusting a phase angle of the at least one first ram, for example internal ram, in relation to a phase angle of the at least one second ram, for example external ram, by means of at least one electronically controlled rotational movement of at least one drive shaft.

The achievement of such an adjustment of a phase shift, for example, is that movements of the first ram, for example internal ram, no longer run in a sinusoidal manner and the draw depths are able to be varied.

In addition, the present invention provides a method for an adjustment of a phase shift of a multiple-action mechanical transverse shaft press, wherein the multiple-action mechanical transverse shaft press includes at least one first drive shaft for at least one first ram, for example an internal ram, and at least one second drive shaft for at least one second ram, for example an external ram, and wherein the rotational movements of the drive shafts run phase shifted about a phase angle in relation to one another, and wherein the phase shift is adjusted as a result of altering the phase angle by means of accelerating and/or delaying at least one drive shaft in a temporary manner.

Very diverse movements of the rams via the drive shafts are made possible in this way, resulting in a particularly high degree of flexibility during the operation of such a multiple-action mechanical transverse shaft press. It is additionally particularly advantageous that the multiple-action mechanical transverse shaft press does not need to be completely stopped. Shifting or adjusting the phase offset is then consequently also possible when the press is operating. This provides a considerable economic advantage.

Acceleration means, in this connection, the faster movement of the drive shaft in its previously carried out rotational movement. Delaying means, on the one hand, a slowed-down movement of the previously carried out rotational movement. On the other hand, delaying means altering the direction of rotation. This means both drive shafts can be varied in an arbitrary manner with regard to their rotational movements. As this also has an effect on the movement of the respective ram, the movements thereof can also be varied in an arbitrary manner. Overall, as a result, it is possible to configure an operating cycle in an arbitrary manner.

In a particularly advantageous further development of the present invention, it is provided that at least one drive shaft is driven by means of a servomotor.

This makes it possible to drive the respective drive shaft faster, which can result in economic advantages during operation.

In particular, in the case of direct drive, without any interposition of energy-storing components (such as, for example, a flywheel), the use of a servomotor with correspondingly high performance/dynamics is capable of providing almost arbitrary movement sequences. In this connection, this can be, for example, movements which can deviate from a sinusoidal progression.

In addition, so-called pendulum movements can be generated, i.e. movements with substantially incomplete revolutions or movement with at least one reversal of the direction of rotation. This is to be seen in such a manner that, for example, one revolution is effected in a clockwise manner and a revolution following this is effected in an anticlockwise manner. Increases in stroke speeds or increases in productivity are obtained in an advantageous manner as a result.

Within the sense of the present invention, the term pendulum movement equates with the term pendulum stroke.

It can also be provided in a further development that a rotational movement of each drive shaft is effected independently of one another by means of at least one electronic control unit each.

This enables further flexibility during the operation of such forming machines.

A configuration of the present invention can provide that individual actuation of a respective direct drive of each ram is effected in at least one operating cycle.

Delayed or leading movement can be achieved in this manner.

Within the sense of the present invention, an operating cycle is generally to be understood as the production of a product. In the case of the multiple-action mechanical press, this means punching and holding, followed by deep-drawing. In this connection, the punching or holding is effected by means of the second ram or by the means of the second rams, for example the external ram, and the deep-drawing is effected by means of the first ram, for example the internal ram. An operating cycle also means, proceeding from a starting position, that the operations punching, holding and deep-drawing are carried out by the rams and the rams are then moved back into the starting position again. This is then followed by a further, new operating cycle.

In an advantageous manner, both drive shafts can be separately controlled or regulated. Flexibility in the operation of the mechanical transverse shaft press is increased as a result.

In an advantageous further development of the present invention, it can also be provided that a rotational movement of each drive shaft is effected by means of a common electronic control unit.

A common control unit provides a simplified solution with regard to the necessary electronic components, for example, hardware. As a result, maintenance expenditure can also be reduced.

Within the sense of the present invention, the rotational movement of the drive shaft is to be understood as the rotary movement of the drive shaft.

In a further configuration of the present invention, it can be provided that the phase shift is adjusted during a stroke of at least one ram.

In a further configuration of the present invention, it can be provided that the phase shift is adjusted during a pendulum stroke of at least one ram.

A pendulum stroke, in this connection, means that a stroke height of a ram is adjusted to a required minimum amount and the drive or the drive shaft does not make any full revolutions, but continuously changes its direction of movement. This offers clear advantages. As a result of the adjustable ram speed, the press can be opened or closed in a faster manner such that shorter cycle times are achievable. In combination with the pendulum stroke, depending on the forming process, increases in productivity of up to 100% can be produced in this way. In addition, it is possible to reduce the ram speed in the tool contact region, as a result of which the forming quality is increased, and tool wear reduced.

It is possible to realize increased flexibility of the multiple-action mechanical transverse shaft press during a stroke, that is to say also within one operating cycle, by means, for example, of such pendulum movements.

In this connection, a stroke of a ram is to be understood first of all as a translatory movement. The translatory movement is as a result of the movement of an eccentric which is driven by means of a drive shaft. The eccentric can act directly on a connecting rod or a knuckle joint drive.

The present invention can also be comprehended in such a manner that, in the case of a multiple-action mechanical transverse shaft press which includes at least two drive shafts, by means of which at least one ram each is moved, the relative movements of the drive shafts with respect to one another are changed at least in a temporary manner by means of at least one electronic control unit.

This means in other words that one drive shaft is accelerated, for example, in relation to the other drive shaft. In a sequence, the movement of the ram accelerated by the accelerated drive shaft is also accelerated. A phase shift of the at least two rams can be adjusted steplessly in this way. The adjustment can be carried out in practice in a particularly advantageous manner whilst the operation is on-going.

In addition, it is conceivable for the direction of rotation of a drive shaft to be altered. Thus, for example, it is possible to adjust one drive shaft in one direction of rotation and a second drive shaft in a direction of rotation which is opposite to the direction of rotation of the first drive shaft.

It is also possible to alter the drive shafts prior to, after or during a stroke or an operating cycle. It is also possible to carry out different changes with reference to the movement of at least one drive shaft prior to, after or during a stroke or an operating cycle.

### BRIEF DESCRIPTION OF THE DRAWINGS

Further configurations of the present invention are produced from the drawings and from the following description of an exemplary embodiment, in which:

FIG. 1 shows a schematic representation of a multiple-action mechanical transverse shaft press; and

FIG. 2 shows a sectioned representation of the multiple-action transverse shaft press shown in FIG. 1.

### DETAILED DESCRIPTION OF THE INVENTION

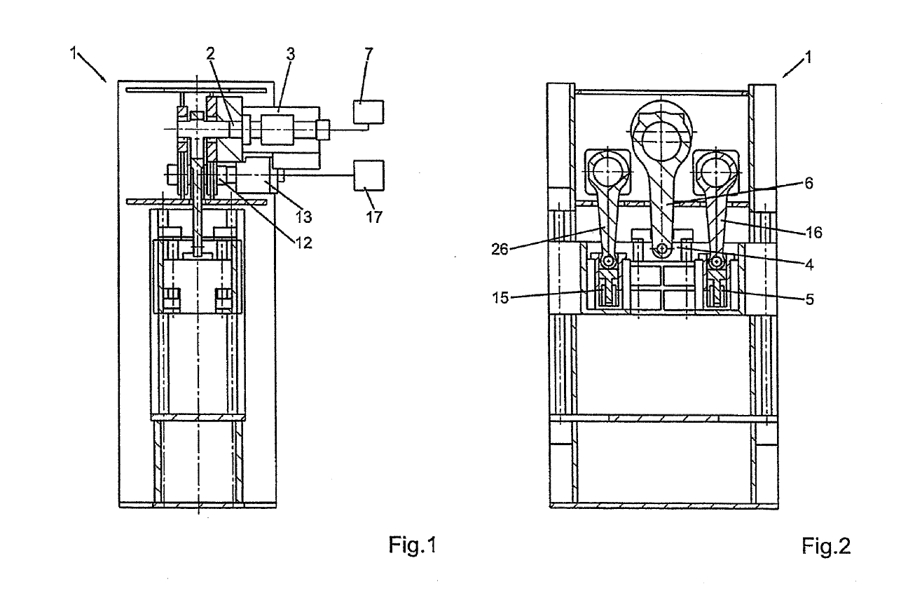

FIG. 1 shows a schematic representation of a multiple-action mechanical transverse shaft press 1. A dual-acting press is shown in the exemplary embodiment. This includes two drive shafts 2, 12 which are arranged in parallel. The two drive shafts 2, 12 are in each case driven by means of one drive 3, 13 each. In addition, the multiple-action mechanical transverse shaft press 1 includes eccentrics, which are not shown in any more detail here and are connected to an internal ram and an external ram, neither of which are shown in any more detail here either, and to the drive shafts 2, 12 and can be moved by means of the associated drives 3, 13. Additionally shown in the exemplary embodiment are two control units 7, 17, by way of which the respective drives 3, 13 are controllable or regulatable. It is, however, also possible to control or regulate by means of just a so-called press controller or a control system.

The control of the drives 3, 13 is effected in such a manner that a phase angle of second ram 5, 15, for example external ram, to first ram 4, for example internal ram, is adjusted by means of the eccentrics 6, 16, 26. It is insignificant, in this case, whether a first drive shaft 2 of the first ram 4, for example internal ram, or the second drive shaft 12 of the second ram 5, 15, for example external ram, is moved.

Apart from this, more than two drive shafts (2, 12), which correspondingly drive more than two rams, can also be present.

FIG. 2 shows a sectioned view of the multiple-action transverse shaft press 1 shown in FIG. 1. In this connection, it can be seen that internal ram 4 and external ram 5, 15 are connected to the eccentrics 6, 16 and 26.

### LIST OF REFERENCES

1 Multiple-action mechanical press
2 First drive shaft
3 Drive
4 First ram
5 Second ram
6 Eccentric
7 Electronic control unit
12 Second drive shaft
13 Drive
15 External ram
16 Eccentric
17 Electronic control unit
26 Eccentric

1. A method for an adjustment of a phase shift of the movement of at least one first ram, for example internal ram, which is pivotally mounted by means of at least one drive shaft, in relation to the movement of at least one second ram, for example external ram, which is pivotally mounted by means of at least one drive shaft, of a multiple-action mechanical transverse shaft press,
comprising the following method steps:
a) stopping, delaying or accelerating at least one drive shaft; and
b) adjusting a phase angle of the at least one first ram, for example internal ram, in relation to a phase angle of the at least one second ram, for example external ram, by means of at least one electronically controlled rotational movement of at least one drive shaft.

2. A method for an adjustment of a phase shift of a multiple-action mechanical transverse shaft press, wherein the multiple-action mechanical transverse shaft press includes at least one first drive shaft for at least one first ram and at least one second drive shaft for at least one second ram, and wherein the rotational movements of the drive shafts run phase shifted about a phase angle in relation to one another,
wherein the phase shift is adjusted as a result of altering the phase angle by means of accelerating and/or delaying at least one drive shaft in a temporary manner.

3. The method as claimed in claim 1, wherein at least one drive shaft is driven by means of a servomotor.

4. The method as claimed in claim 1, wherein a rotational movement of each drive shaft is effected independently of one another by means of at least one electronic control unit each.

5. The method as claimed in claim 1, wherein a rotational movement of each drive shaft is effected by means of a common electronic control unit.

6. The method as claimed in claim 1, wherein individual actuation of a respective direct drive of each ram is effected within one operating cycle.

7. The method as claimed in claim 1, wherein the phase shift is adjusted during a stroke of at least one ram.

8. A multiple-action mechanical transverse shaft press, wherein a movement sequence is effected as claimed in claim 1.

9. The method as claimed in claim 1, wherein the phase shift is adjusted during a pendulum stroke of at least one ram.

10. The method as claimed in claim 2, wherein the first ram is an internal ram and the second ram is an external ram.

11. The method as claimed in claim 2, wherein at least one drive shaft is driven by means of a servomotor.

12. The method as claimed in claim 1, wherein at least one drive shaft is directly driven by means of a servomotor.

13. The method as claimed in claim 2, wherein at least one drive shaft is directly driven by means of a servomotor.

14. The method as claimed in claim 2, wherein a rotational movement of each drive shaft is effected independently of one another by means of at least one electronic control unit each.

15. The method as claimed in claim 2, wherein a rotational movement of each drive shaft is effected by means of a common electronic control unit.

16. The method as claimed in claim 2, wherein individual actuation of a respective direct drive of each ram is effected within one operating cycle.

17. The method as claimed in claim 2, wherein the phase shift is adjusted during a stroke of at least one ram.

18. A multiple-action mechanical transverse shaft press, wherein a movement sequence is effected as claimed in claim 2.

19. The method as claimed in claim 2, wherein the phase shift is adjusted during a pendulum stroke of at least one ram.
